(19) United States
(12) Patent Application Publication
(10) Pub. No.: US 2012/0026304 A1
(43) Pub. Date: Feb. 2, 2012

(54) STEREOSCOPIC VIDEO OUTPUT DEVICE AND BACKLIGHT CONTROL METHOD

(75) Inventor: Kunihiko Kawahara, Tokyo (JP)

(73) Assignee: Kabushiki Kaisha Toshiba, Tokyo (JP)

(21) Appl. No.: 13/094,307

(22) Filed: Apr. 26, 2011

(30) Foreign Application Priority Data
Jul. 27, 2010 (JP) 2010-168345

(51) Int. Cl. H04N 13/04

(52) U.S. Cl. 348/55; 348/E13.075

(57) ABSTRACT

According to one embodiment, a stereoscopic video output device includes a video display module, a backlight, a first backlight controller, a second backlight controller, a signal converter, and a light controller. The video display module displays stereoscopic video based on a left-eye video frame and a right-eye video frame having disparity output in a time-division manner. The backlight illuminates the video display module. The first backlight controller controls the amount of light emitted by the backlight based on the left-eye video frame, while the second backlight controller controls the amount of light based on the right-eye video frame. The signal converter merges left-eye and right-eye video backlight control signals arranged in order to generate a new backlight control signal. The light controller turns on the backlight synchronously with the left-eye video frame and the right-eye video frame sequentially output from the video display module based on the backlight control signal.

### CROSS-REFERENCE TO RELATED APPLICATIONS

This application is based upon and claims the benefit of priority from Japanese Patent Application No. 2010-168345, filed Jul. 27, 2010, the entire contents of which are incorporated herein by reference.

### FIELD

Embodiments described herein relate generally to a stereoscopic video output device and a backlight control method.

### BACKGROUND

There have been developed technologies for enabling users to view stereoscopic video on a flat display screen. Such a technology uses two types of video images having disparity corresponding to the interocular distance such that a user views a video image for right eye with his/her right eye and a video image for left eye with his/her left eye, thereby enabling the user to view stereoscopic video. More specifically, right-eye and left-eye video images are output in a time-division multiplexing manner and are alternately displayed on the same display screen. The shutters of stereoscopic glasses worn by the user are controlled such that the left-eye shutter is closed when a right-eye video image is being displayed while the right-eye shutter is closed when a left-eye video image is being displayed. This enables the user to experience stereoscopic video.

In recent years, there have been developed video display devices provided with a liquid crystal display (LCD) panel that is illuminated from behind by a light emitting diode (LED) used in the backlight. Taking advantage of the characteristic of LED that the brightness is easily controlled, such a video display device using LED for the backlight is capable of achieving video playback with a high contrast ratio.

When the LCD panel using LED for the backlight is applied to a time-division multiplexed stereoscopic video output device, considering the feature that right-eye and left-eye video images are output in a time-division multiplexing manner and are alternately displayed on the same display screen, it is required to achieve video playback with a high contrast ratio through the highly accurate control of the LED backlight.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external perspective view of a digital TV (TV) according to an embodiment;

FIG. 2 is an exemplary block diagram of a signal processing system of the digital TV in the embodiment;

FIG. 3 is an exemplary block diagram of a superposition processor in the embodiment;

FIG. 4 is an exemplary block diagram of stereoscopic glasses in the embodiment;

FIG. 5 is an exemplary block diagram of a video processor in the embodiment; and

FIG. 6 is an exemplary block diagram of a backlight control signal generator in the embodiment.

### DETAILED DESCRIPTION

In general, according to one embodiment, a stereoscopic video output device comprises a video display module, a backlight module, a first backlight controller, a second backlight controller, a signal converter, and a light controller. The video display module is configured to display stereoscopic video based on a left-eye video frame and a right-eye video frame for stereoscopic display output in a time-division manner. Disparity exists between the left-eye video frame and the right-eye video frame. The backlight module is configured to illuminate the video display module from behind. The first backlight controller is configured to control the amount of light emitted by the backlight module based on the left-eye video frame. The second backlight controller is configured to control the amount of light emitted by the backlight module based on the right-eye video frame. The signal converter is configured to merge a left-eye video backlight control signal generated by the first backlight controller and a right-eye video backlight control signal generated by the second backlight controller arranged in order to generate a new backlight control signal. The light controller is configured to turn on the backlight module synchronously with the left-eye video frame and the right-eye video frame sequentially output from the video display module based on the backlight control signal generated by the signal converter.

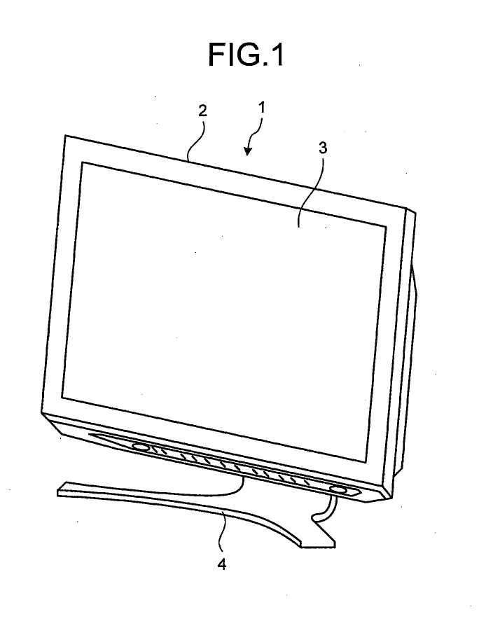

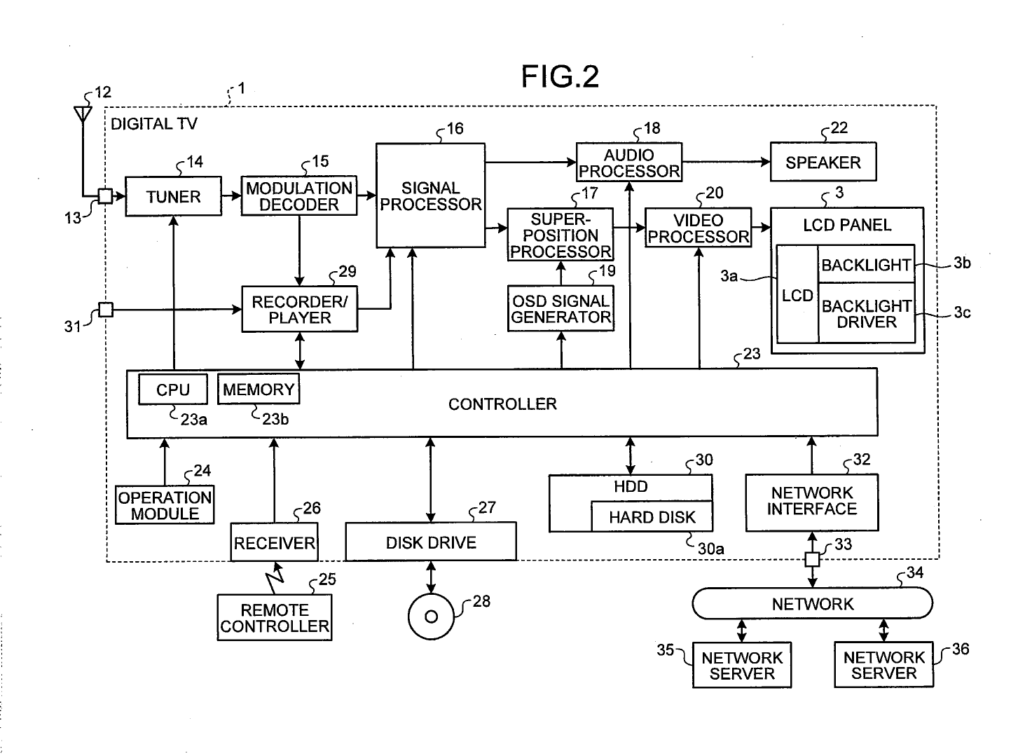

FIG. 1 is an external perspective view of a digital TV (TV) 1 as an example of a stereoscopic video output device according to an embodiment. As illustrated in FIG. 1, the digital TV 1 has a rectangular appearance viewed from the front (in a plane view from the front). The digital TV 1 comprises a housing 2 and a liquid crystal display (LCD) panel 3. The LCD panel 3 receives a video signal from a video processor 20 (see FIG. 2), which will be described later, and displays video including still images and moving images. The housing 2 is supported by a support base 4.

FIG. 2 is a block diagram of a signal processing system of the digital TV 1. The digital TV 1 is capable of video display based on video signals for stereoscopic (three-dimensional) display as well as video display based on video signals for regular planar (two-dimensional) display.

As illustrated in FIG. 2, the digital TV 1 receives digital TV broadcast signals by an antenna 12 and then supplies the signals via an input terminal 13 to a tuner 14, at which a broadcast signal of a desired channel is selected.

The digital TV 1 supplies the broadcast signal selected by the tuner 14 to a modulation decoder 15 to decode the broadcast signal into a digital video signal and a digital audio signal. Those signals are then output to a signal processor 16.

The signal processor 16 performs predetermined digital signal processing on the digital video signal and the digital audio signal received from the modulation decoder 15. The digital signal processing performed by the signal processor 16 includes conversion of a video signal for regular planar (two-dimensional) display into a video signal for stereoscopic (three-dimensional) display, conversion of a video signal for stereoscopic display into a video signal for planar display, and the like.

The signal processor 16 outputs the digital video signal to a superposition processor 17 and the digital audio signal to an audio processor 18.

On the digital video signal received from the signal processor 16, the superposition processor 17 superimposes an on screen display (OSD) signal generated by an OSD signal generator 19 and then outputs the resultant signal. The OSD signal is a video signal to superimpose subtitles, graphical user interface (GUI), OSD, and the like on the digital video signal. If the video signal received from the signal processor 16 is the one for regular planar display, the superposition processor 17 directly superimposes an OSD signal generated by the OSD signal generator 19 on the digital video signal, and then outputs the resultant signal. On the other hand, if the video signal supplied by the signal processor 16 is the one for stereoscopic display, the superposition processor 17 performs signal processing for stereoscopic display corresponding to the input video signal on an OSD signal generated by the OSD signal generator 19 before superimposing the OSD signal on the input video signal, and then outputs the resultant signal.

The digital TV 1 supplies the digital video signal output from the superposition processor 17 to the video processor 20. The video processor 20 converts the digital video signal into an analog video signal in a format displayable on the LCD panel 3. The digital TV 1 supplies the analog video signal output from the video processor 20 to the LCD panel 3 for video display.

As illustrated in FIG. 2, the LCD panel 3 comprises an LCD 3a functioning as a video display module, a backlight 3b that illuminates the LCD 3a from behind, and a backlight driver 3c that drives the backlight 3b. The backlight 3b comprises a number of light-emitting diodes (LEDs) as light sources, and the light emission can be controlled with respect to each area by the backlight driver 3c. The backlight 3b and the backlight driver 3c constitute a backlight module.

The audio processor 18 converts the input digital audio signal into an analog audio signal in a format reproducible by a speaker 22. The analog audio signal output from the audio processor 18 is supplied to the speaker 22 for audio playback.

A controller 23 controls the overall operation of the digital TV 1 including the various receiving operations as described above. The controller 23 comprises a built-in central processing unit (CPU) 23a. Upon receipt of operation information from an operation module 24 installed in the main body of the digital TV 1 or upon receipt of operation information from a remote controller 25 by a receiver 26, the controller 23 controls the respective modules to reflect the received operation information.

The controller 23 uses a memory 23b, which mainly comprises a read only memory (ROM) that stores a control program to be executed by the CPU 23a, a random access memory (RAM) that provides a work area to the CPU 23a, and a nonvolatile memory that stores various types of setting information and control information. To the controller 23 is connected a disk drive 27. The disk drive 27 allows an optical disk 28 such as a digital versatile disk (DVD) to be removably mounted thereon and has the function of reading/writing digital data with respect to the optical disk 28.

In response to the user operation on the operation module 24 or the remote controller 25, the controller 23 controls a recorder/player 29 to encode the digital video signal and the digital audio signal obtained from the modulation decoder 15 to convert the signals into a predetermined recording format and then supply the signals to the disk drive 27 to record the signals on the optical disk 28.

Besides, in response to the user operation on the operation module 24 or the remote controller 25, the controller 23 controls the disk drive 27 to read the digital video signal and the digital audio signal from the optical disk 28, and the recorder/player 29 to decode the signals and then to supply the signals to the signal processor 16 for video display and audio playback as described above.

To the controller 23 is connected a hard disk drive (HDD) 30. In response to the user operation on the operation module 24 or the remote controller 25, the controller 23 controls the recorder/player 29 to encode the digital video signal and the digital audio signal obtained from the modulation decoder 15 to convert the signals into a predetermined recording format and then supply the signals to the HDD 30 to record the signals on a hard disk 30a.

Further, in response to the user operation on the operation module 24 or the remote controller 25, the controller 23 controls the HDD 30 to read the digital video signal and the digital audio signal from the hard disk 30a, and the recorder/player 29 to decode the signals and then to supply the signals to the signal processor 16 for video display and audio playback as described above.

An input terminal 31 is connected to the digital TV 1 to directly receive digital video and audio signals from the outside. Under the control of the controller 23, the digital video and audio signals received via the input terminal 31 are supplied to the signal processor 16 via the recorder/player 29 for video display and audio playback as described above.

Moreover, under the control of the controller 23, the digital video and audio signals received via the input terminal 31 are processed by the recorder/player 29, and are read/written with respect to the optical disk 28 by the disk drive 27 or with respect to the hard disk 30a by the HDD 30.

Meanwhile, based on the user operation on the operation module 24 or the remote controller 25, the controller 23 controls the disk drive 27 and the HDD 30 to record digital video and audio signals recorded on the optical disk 28 on the hard disk 30a, and to record digital video and audio signals recorded on the hard disk 30a on the optical disk 28.

The controller 23 is connected to a network interface 32, which is further connected to an external network 34 via an input/output terminal 33. The network 34 is connected to a plurality of (two in the example of FIG. 2) network servers 35 and 36 to provide various services using the communication function through the network 34. Via the network interface 32, the input/output terminal 33, and the network 34, the controller 23 accesses desired one of the network servers 35 and 36 for information communication and thereby can use services provided by the server.

On the digital TV 1, information including video and audio obtained from the disk drive 27 and the HDD 30 can be played, stopped, and paused with the play, stop, and pause keys on the remote controller 25. Further, while information including video and audio is being played by the disk drive 27 or the HDD 30, a predetermined amount of the information can be skipped forward or backward with the skip forward or skip backward key on the remote controller 25. Still further, while information including video and audio is being played by the disk drive 27 or the HDD 30, the playback can be fast forwarded or rewound with the fast-forward or fast-rewind key on the remote controller 25.

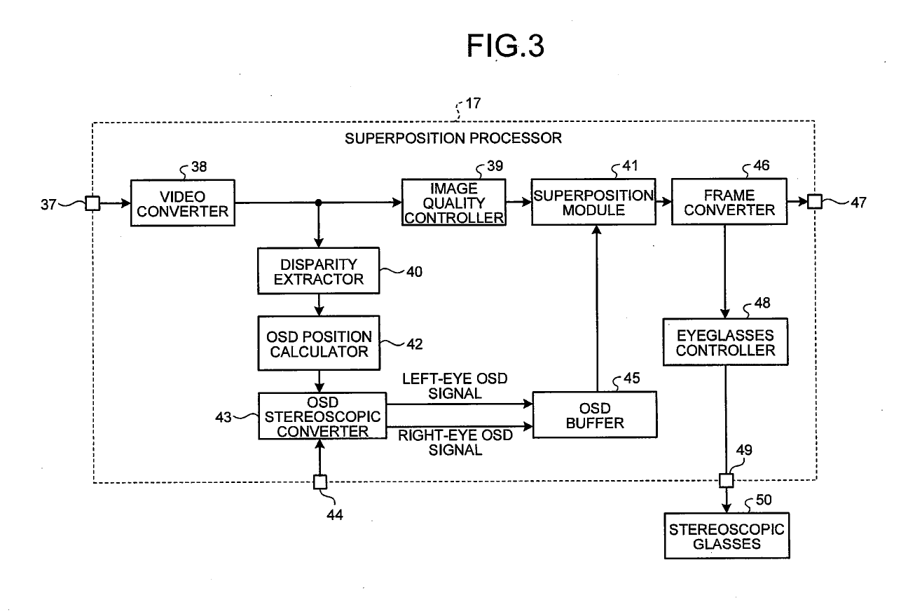

FIG. 3 is a block diagram of the superposition processor 17. As illustrated in FIG. 3, in the superposition processor 17, a digital video signal output from the signal processor 16 is supplied to a video converter 38 functioning as a video generator via an input terminal 37.

If an input video signal is the one for stereoscopic (three-dimensional) display, the video converter 38 converts the video signal into a specific video format, and then outputs it to an image quality controller 39 and a disparity extractor 40. Regarding a video signal for stereoscopic display, various video formats are available. Examples of the video formats include a frame packing (top-and-bottom) format, a side-by-side format, an interleave format, and the like. In the frame packing format, within a single frame synchronization period, a right-eye video frame is output after a left-eye video frame. In the side-by-side format, within a single horizontal period, a right-eye video line is output after a left-eye video line. Besides, in each video format, there exists a variety regarding the video size or the scanning method (interlace/progressive), and the like. Thus, in the digital TV 1 of the embodiment, the video converter 38 performs appropriate processing such as scaling or interlace/progressive (IP) conversion on an input video signal for stereoscopic display. As a result, the video signal is converted into a frame sequential video format in a video size of 1920 pixels horizontal×1080 lines vertical. Then, the video converter 38 outputs the video signal to the image quality controller 39 and the disparity extractor 90. In frame sequential mode, L (left-eye) and R (right-eye) video images are output in a time-division multiplexing manner with respect to each frame, and are alternately displayed on the LCD panel 3.

That is, the digital TV 1 of the embodiment is compatible with various video formats for stereoscopic display in addition to the frame sequential video format.

The video converter 38 also performs super-resolution processing. In the super-resolution processing, a provisional low-resolution image obtained by down-converting an up-converted provisional high-resolution image is compared with an image obtained by enhancing an original input image using an unsharp mask to restore the original image signal of the original input image. The repetition of comparisons and restorations improves the accuracy of the super-resolution processing. As the super-resolution processing, the process of comparison and restoration may be performed once or a plurality of times. If there is enough time, such as when recorded video is viewed later or a time lag occurring in the super-resolution processing is acceptable, the process of comparison and restoration may be performed a plurality of times in the super-resolution processing.

How the super-resolution processing is performed in the video converter 38 is not limited as described above. Various methods may be used as examples of the process of restoring a high-resolution image signal by estimating an original pixel value from a low- or intermediate-resolution image signal and increasing the pixels. The super-resolution processing includes a process in which the resolution histogram of video is analyzed and optimal high-quality image processing is performed according to the resolution. For example, upon receipt of a video signal with a high definition (HD) resolution (1920×1080 pixels), the resolution histogram of the video is analyzed, and sharpening is performed according to the resolution (1920×1080 pixels). In this case, the super-resolution processing can increase the resolution of the image that the user feels without a change in the resolution.

The super-resolution processing performed in the video converter 38 realizes a stereoscopic image with high resolution. Especially, in the frame packing format, the side-by-side format, and the interleave format, video is received in a half resolution of the original. Therefore, the super-resolution processing achieves stereoscopic video having nearly the resolution of the original.

The video converter 38 also has the function of a frame rate converter by frame interpolation or extrapolation. This enables low frame-rate video to be up-converted. Although frame sequential video data often has a low frame rate, the up-conversion achieves stereoscopic video having a higher frame rate.

With respect to an input video signal, the image quality controller 39 performs image quality adjustment such as brightness adjustment, contrast adjustment, and hue adjustment under the control of the controller 23. The image quality controller 39 then synchronizes the video signal to a vertical synchronization signal and outputs it to a superposition module 41.

With respect to a video signal for stereoscopic display that has been converted into the frame sequential video format by the video converter 38, the disparity extractor 40 compares a left-eye video frame with a right-eye video frame to extract disparity therebetween. In the disparity extraction performed by the disparity extractor 40, based on the position of an object displayed in the left-eye video frame, a horizontal gap in the position of the same object displayed in the right-eye video frame is represented by the number of pixels. The disparity extraction can be performed without difficulty by the technology of motion vector for detecting the shifting positions of the same object displayed in consecutive frames.

More specifically, numbers 1 to 1920 are assigned to 1920 pixels arranged in the horizontal direction on the screen. Then, from the number of the pixel at a predetermined position of an object displayed in the left-eye video frame, the number of the pixel at the same predetermined position of the object displayed in the right-eye video frame is subtracted. Thus, the disparity can be represented by the number of pixels.

In this case, if the disparity is a negative value, it means that a right-eye video image lies on the right side than a left-eye video image, and the image of the object is formed deep in the screen. On the other hand, if the disparity is a positive value, it means that a right-eye video image lies on the left side than a left-eye video image, and the image of the object is formed in front of the screen.

The disparity amount extracted by the disparity extractor 40 is supplied to an OSD position calculator 42 functioning as a video generator. The OSD position calculator 42 performs calculation to correct the display position for displaying OSD in a stereoscopic manner based on the received disparity amount. The OSD position calculator 42 then outputs a disparity control signal indicating the calculation result.

More specifically, when the disparity amount extracted by the disparity extractor 40 does not vary in the temporal axis direction or when the disparity amount is moderately varying in the temporal axis direction during video display, the OSD position calculator 42 performs calculation to correct the display position for displaying OSD in a stereoscopic manner. That is, when the disparity amount is drastically varying in the temporal axis direction, video is drastically moving in the depth direction. In such a state, the user is conscious of the video, and if superimposed OSD also drastically moves in the depth direction, the video is visually undesirable. Accordingly, when the disparity amount is drastically varying, the OSD position calculator 42 outputs a disparity control signal indicating a result calculated when the disparity amount varies a little.

The disparity control signal output from the OSD position calculator 42 is supplied to an OSD stereoscopic converter 43. Besides, an OSD signal output from the OSD signal generator 19 is also supplied to the OSD stereoscopic converter 43 via an input terminal 44. The OSD stereoscopic converter 43 generates a left-eye OSD signal to be superimposed on a left-eye video frame and a right-eye OSD signal to be superimposed on a right-eye video frame from the received OSD signal based on the disparity control signal. The OSD stereoscopic converter 43 stores the OSD signals in an OSD buffer 45.

More specifically, when supplied with an OSD signal for brightness control from the OSD signal generator 19, the OSD stereoscopic converter 43 stores left-eye and right-eye OSD signals in the OSD buffer 45 to display brightness adjustment OSDs for left and right eyes having horizontal disparity (position gap) corresponding to the number of pixels based on a disparity control signal in left-eye and right-eye video frames, respectively, on the frame sequential video format in a video size of 1920 pixels horizontal×1080 lines vertical. The left-eye and right-eye OSD signals stored in the OSD buffer 45 are output synchronously to the superposition module 41.

The superposition module 41 combines a video signal output from the image quality controller 39 and a video signal output from the OSD buffer 45. In this case, a left-eye OSD signal output from the OSD buffer 45 is superimposed on a video signal of a left-eye video frame output from the image quality controller 39. Similarly, a right-eye OSD signal output from the OSD buffer 45 is superimposed on a video signal of a right-eye video frame output from the image quality controller 39.

Subsequently, the video signals obtained by the superposition module 41 are supplied to a frame converter 46. In the frame converter 46, the vertical synchronization frequency of the video, signals is doubled, i.e., the frame frequency is doubled in speed. Then, the video signals are output through an output terminal 47 to the LCD 3a of the LCD panel 3 via the video processor 20. Thus, on the LCD 3a of the LCD panel 3, the left-eye video frame superimposed with the left-eye OSD signal and the right-eye video frame superimposed with the right-eye OSD signal are alternately displayed. That is, the LCD 3a functioning as a video display module has the function of outputting left-eye and right-eye video frames in a time-division multiplexing manner.

A frame synchronization signal generated by the frame converter 46 is supplied to an eyeglasses controller 48. The eyeglasses controller 48 generates left-eye and right-eye shutter control signals based on the frame synchronization signal received from the frame converter 46, and outputs the shutter control signals through an output terminal 49 to stereoscopic glasses 50 worn by the user.

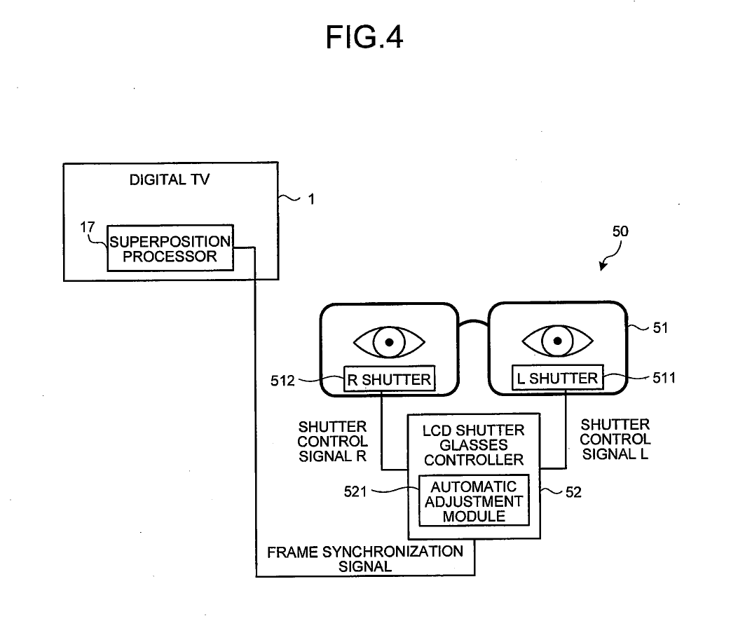

FIG. 4 is a block diagram of the stereoscopic glasses 50. As illustrated in FIG. 4, the stereoscopic glasses 50 comprise LCD shutter glasses 51 and an LCD shutter glasses controller 52.

The LCD shutter glasses 51 comprise a left-eye LCD shutter (L shutter) 511 obstruct or allow the left eye to view and a right-eye LCD shutter (R shutter) 512 obstruct or allow the right eye to view. The user views left-eye and right-eye images displayed alternately with his/her left and right eyes, respectively, while wearing the LCD shutter glasses 51. Thus, the user experiences stereoscopic vision.

As illustrated in FIG. 4, the LCD shutter glasses controller 52 receives a frame synchronization signal output from the superposition processor 17 together with frame data for alternately displaying left-eye and right-eye images on the digital TV 1. The LCD shutter glasses controller 52 generates shutter control signals L and R to open/close the L shutter 511 and the R shutter 512, respectively, based on the frame synchronization signal. The LCD shutter glasses controller 52 supplies the shutter control signals L and R to the LCD shutter glasses 51. The LCD shutter glasses controller 52 comprises an automatic adjustment module 521 to automatically adjust the shutter control signals L and R.

The eyeglasses controller 48 of the superposition processor 17 controls the stereoscopic glasses 50 such that the R shutter 512 is closed when left-eye video is being displayed, while the L shutter 511 is closed when right-eye video is being displayed. This allows the user to experience stereoscopic vision.

If a digital video signal output from the signal processor 16 is the one for regular planar (two-dimensional) display, left-eye and right-eye video frames output in the frame packing format from the video converter 38 represent the same video. Accordingly, a disparity amount extracted by the disparity extractor 40 is zero. In this case, the OSD stereoscopic converter 43 stores, in the OSD buffer 45, OSD signals received from the OSD signal generator 19 to be displayed at the same position in left-eye and right-eye video frames, respectively, on the frame sequential video format. With this, the superposition module 41 outputs video signals for regular planar (two-dimensional) display superimposed with the OSD signals. The frame converter 46 converts the video signals so that the frame frequency is doubled in speed. The video signals are output through the output terminal 47 to the LCD 3a of the LCD panel 3 via the video processor 20 and are displayed as video for regular planar (two-dimensional) display.

Upon displaying OSD, the digital TV 1 determines disparity between left-eye and right-eye OSD signals based on disparity between left-eye and right-eye video frames to be displayed in a stereoscopic manner. Then, the left-eye and right-eye OSD signals are superimposed on video signals of the left-eye and right-eye video frames, respectively. With this, the OSD can be displayed on stereoscopic video without a feeling of strangeness. Moreover, the user can recognize the OSD displayed while viewing the stereoscopic video and also display the OSD while viewing the stereoscopic video, which facilitates to make various adjustments, settings, or the like. Thus, the usability can be improved for the user.

While the digital TV 1 of the embodiment is described above as displaying OSD while stereoscopic video is being displayed, information to be displayed is not limited to OSD. For example, the digital TV 1 has wide application to, in addition to display video based on video signals obtained from broadcasting, the optical disk 28, the hard disk 30a, the network servers 35 and 36, and the like, a screen display signal that the digital TV 1 originally generates and can display.

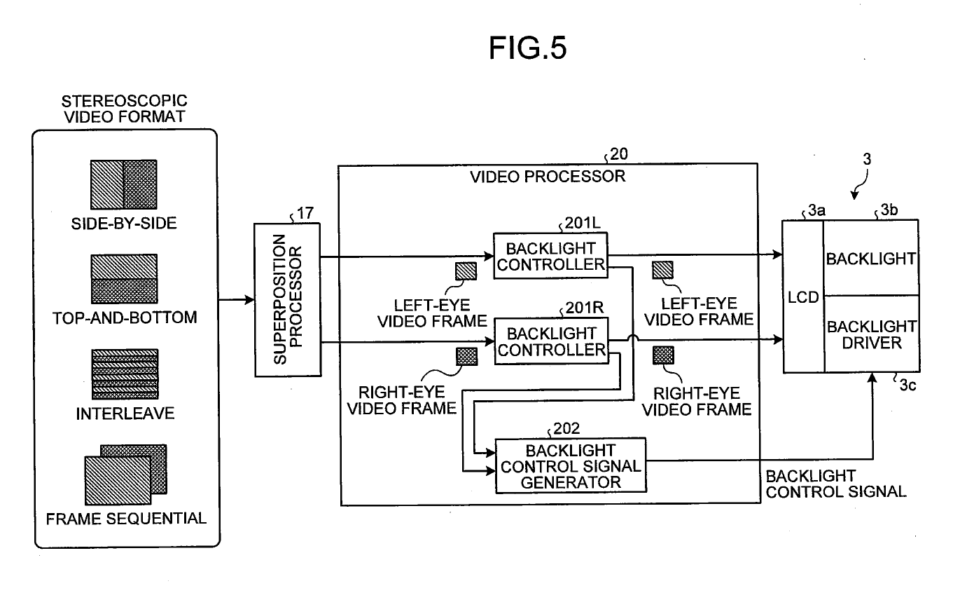

A detailed description will be given of the video processor 20 having the salient feature of the digital TV 1 of the embodiment. FIG. 5 is a block diagram of the video processor 20. As illustrated in FIG. 5, the video processor 20 comprises a backlight controller 201L as a first backlight controller, a backlight controller 201R as a second backlight controller, and a backlight control signal generator 202. The backlight controller 201L is supplied with a left-eye video frame generated by the superposition processor 17. Meanwhile, the backlight controller 201R is supplied with a right-eye video frame generated by the superposition processor 17.

The backlight controllers 201L and 201R control the amount of light emitted from each LED that constitutes the backlight 3b of the LCD panel 3. More specifically, by dividing screen (frame) into areas, the backlight controllers 201L and 201R control the amount of light emitted from each LED that constitutes the backlight 3b of the LCD panel 3 with respect to each area. For example, brightness is detected for each area, and correction is added to, for example, increase the peak brightness. This enables light and dark control with respect to each area, and thereby a sharp video image can be displayed. A left-eye video backlight control signal generated by the backlight controller 201L and a right-eye video backlight control signal generated by the backlight controller 201R are supplied to the backlight control signal generator 202.

Besides, the backlight controllers 201L and 201R detect an black area using the histogram of the entire screen (the entire frame), and also optimize video according to the light value of each LED that constitutes the backlight 3b in each area. This increases the contrast of each scene and achieves fine gradation. The left-eye video frame optimized by the backlight controller 201L and the right-eye video frame optimized by the backlight controller 201R are supplied to the LCD 3a of the LCD panel 3.

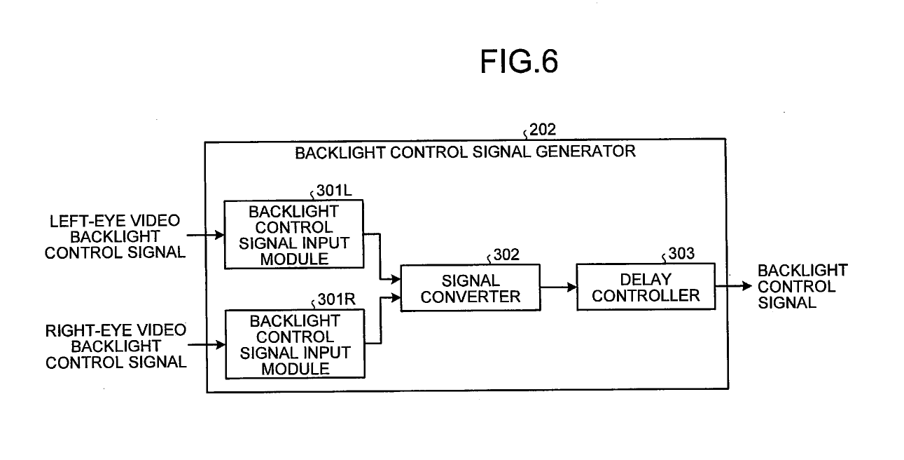

The backlight control signal generator 202 merges the left-eye video backlight control signal generated by the backlight controller 201L and the right-eye video backlight control signal generated by the backlight controller 201R, thereby generating a backlight control signal. FIG. 6 is a block diagram of the backlight control signal generator 202. As illustrated in FIG. 6, the backlight control signal generator 202 comprises a backlight control signal input module 301L, a backlight control signal input module 301R, a signal converter 302, and a delay controller 303 as a light controller.

The backlight control signal input module 301L receives the left-eye video backlight control signal generated by the backlight controller 201L. Meanwhile, the backlight control signal input module 301R receives the right-eye video backlight control signal generated by the backlight controller 201R.

The signal converter 302 converts the backlight control signals (the left-eye and right-eye video backlight control signals) received by the backlight control signal input modules 301L and 301R into a format receivable by the backlight driver 3c of the LCD panel 3. That is, the signal converter 302 merges the left-eye video backlight control signal and the right-eye video backlight control signal arranged in order to generate a new backlight control signal.

The delay controller 303 delays the backlight control signal generated by the signal converter 302 to turn on the backlight 3b synchronously with video images (left-eye and right-eye video frames) sequentially output from the LCD 3a of the LCD panel 3.

Upon receipt of the backlight control signal from the backlight control signal generator 202, the backlight driver 3c of the LCD panel 3 turns on the backlight 3b based on the backlight control signal.

As described above, in the digital TV 1 according to the embodiment, the signal converter 302 merges a left-eye video backlight control signal generated by the backlight controller 201L and a right-eye video backlight control signal generated by the backlight controller 201R arranged in order to generate a new backlight control signal. Besides, the backlight 3b is turned on synchronously with left-eye and right-eye video frames sequentially output from the LCD 3a of the LCD panel 3 based on the backlight control signal generated by the signal converter 302. With this, the backlight can be controlled with high accuracy with respect to left-eye and right-eye video images in the frame sequential video format. Thus, it is possible to achieve stereoscopic video image with a high contrast ratio.

Moreover, in the digital TV 1 according to the embodiment, the left-eye and right-eye video frames are processed by the backlight controllers 201L and 201R, respectively. Thus, a higher frame rate can be achieved compared to the case of using a single backlight controller.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic video output device comprising:
a video display module configured to display stereoscopic video based on a left-eye video frame and a right-eye video frame for stereoscopic display output in a time-division manner, disparity existing between the left-eye video frame and the right-eye video frame;
a backlight module configured to illuminate the video display module from behind;
a first backlight controller configured to control an amount of light emitted by the backlight module based on the left-eye video frame;
a second backlight controller configured to control an amount of light emitted by the backlight module based on the right-eye video frame;
a signal converter configured to merge a left-eye video backlight control signal generated by the first backlight controller and a right-eye video backlight control signal generated by the second backlight controller arranged in order to generate a new backlight control signal; and
a light controller configured to turn on the backlight module synchronously with the left-eye video frame and the right-eye video frame sequentially output from the video display module based on the backlight control signal generated by the signal converter.

2. The stereoscopic video output device of claim 1, wherein the backlight module comprises a plurality of light-emitting diodes.

3. The stereoscopic video output device of claim 2, wherein
the first backlight controller is configured to control an amount of light emitted by the light-emitting diodes of the backlight module with respect to each of areas obtained by dividing the left-eye video frame, and
the second backlight controller is configured to control an amount of light emitted by the light-emitting diodes of the backlight module with respect to each of areas obtained by dividing the right-eye video frame.

4. The stereoscopic video output device of claim 2, wherein
the first backlight controller is configured to detect an black area based on a histogram of the entire left-eye video frame and optimize video according to a light value of each of the light-emitting diodes of the backlight module in each of areas obtained by dividing the left-eye video frame, and
the second backlight controller is configured to detect an black area based on a histogram of the entire right-eye video frame and optimize video according to a light value of each of the light-emitting diodes of the backlight module in each of areas obtained by dividing the right-eye video frame.

5. The stereoscopic video output device of claim 1, further comprising a video converter configured to convert a video signal for stereoscopic display in a format other than a frame sequential format into the frame sequential format to cause the left-eye video frame and the right-eye video frame to be output in a time-division manner and are alternately displayed on the video display module.

6. The stereoscopic video output device of claim 5, wherein the video converter is configured to perform super-resolution processing in which a high-resolution image signal is restored by estimating an original pixel value from a low-resolution image signal or an intermediate-resolution image signal and increasing pixels.

7. The stereoscopic video output device of claim 5, wherein the video converter is configured to up-convert a frame rate by frame interpolation or extrapolation.

8. A backlight control method applied to a stereoscopic video output device comprising a video display module configured to display stereoscopic video based on a left-eye video frame and a right-eye video frame for stereoscopic display output in a time-division manner, disparity existing between the left-eye video frame and the right-eye video frame, and a backlight module configured to illuminate the video display module from behind, the backlight control method comprising:
first controlling an amount of light emitted by the backlight module based on the left-eye video frame;
second controlling an amount of light emitted by the backlight module based on the right-eye video frame;
generating a new backlight control signal by merging a left-eye video backlight control signal generated at the first controlling and a right-eye video backlight control signal generated at the second controlling arranged in order; and
turning on the backlight module synchronously with the left-eye video frame and the right-eye video frame sequentially output from the video display module based on the backlight control signal generated at the generating.
